(19) United States
(12) Patent Application Publication
(10) Pub. No.: US 2002/0111170 A1
(43) Pub. Date: Aug. 15, 2002

(54) Management of an overload situation in a telecommunication system

(76) Inventor: Reijo Romppanen, Oulu (FI)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/082,240

(22) Filed: Feb. 26, 2002

Related U.S. Application Data
(63) Continuation of application No. PCT/FI00/00713, filed on Aug. 22, 2000.

(30) Foreign Application Priority Data
Aug. 26, 1999 (FI) 19991819

(51) Int. Cl. H04Q 7/20

(52) U.S. Cl. 455/453; 455/452

(57) ABSTRACT

Method of clearing an overload situation in a telecommunication system including a first network element, a second network element, subscriber ports included in each network element, and an interface connecting subscriber ports of the first network element to subscriber ports of the second network element. When a signalling channel between the network elements and/or the first network element (LE) are/is overloaded, a subscriber's call attempt is transmitted by the second network element to the first network element, and inhibited in the first network element. A notice is sent by the first network element to the second network element advising that the subscriber's call attempt is to be inhibited in the second network element.

### FIELD OF THE INVENTION

The present invention relates to telecommunication systems. In particular, the invention concerns a method and system for clearing and managing an overload situation.

### BACKGROUND OF THE INVENTION

Open interfaces (V5.1 and V5.2) between an access network and a local exchange are defined in the ETSI (European Telecommunications and Standards Institute) standards of the ETS 300 324 and ETS 300 347 series. V5 interfaces enable subscribers belonging to a physically separate access network to be connected to a telephone exchange using a standard interface. A dynamic concentrator interface V5.2 consistent with the ETS 300 347-1 and 347-2 standards consists of one or more (1-16) PCM (Pulse Code Modulation) lines. One PCM line comprises 32 channels or time slots, each of which has a transfer rate of 64 kbit/s, so the total capacity of the PCM line is 2048 kbit/s. The V5.2 interface supports analog telephones as used in the public telephone network, digital, such as ISDN (Integrated Services Digital Network) basic rate and primary rate interfaces as well as other analog or digital terminal equipment based on semi-fixed connections.

The maximum capacity of a single V5.2 link is about 500 B-channels. This means that there may be about 500 calls going on at the same time. However, since the V5.2 interface is of a concentrating nature, this number of B-channels is sufficient to serve about 5000 subscribers. The subscribers can be connected to the local exchange e.g. via a special access node. The access node is connected to the local exchange e.g. via a V5 interface.

In addition to actual signalling traffic, the V5 interface specifications include separate O&M interfaces (O&M, Operation and Maintenance) for a local exchange and an access network. A management interface Q3 for a local exchange is defined in ETSI standards ETS 300 379-1 and ETS 300 377-1. Management interface means an interface between a local exchange and a telecommunications management network (TMN) A V5 interface comprises two types of time slot: time slots reserved for speech, i.e. B-channels, and time slots reserved for signalling data, i.e. C-channels. In the V5.2 interface, additional standby channels are used for switch-over of signalling channels. The standby channels normally carry no traffic. If a single 2 Mbit/s transmission link is used, then the system automatically allocates time slot 16 for the control protocol. Time slots 16, 15 and 31 can be allocated both for a public network and for ISDN channels. If there are more than one transmission link, then the system allocates time slot 16 of the primary transmission link for the control protocol, the BCC (Bearer Channel Connection) protocol and the channel switch-over protocol. In addition, time slot 16 of a secondary transmission link is allocated as a standby channel. The channel switch-over mechanism of the V5 interface ensures that a V5.2 interface containing multiple transmission links will work even after a malfunction has occurred in an individual PCM transmission link. The channel switch-over mechanism is used to provide backup for all active C-channels. The channel switch-over protocol does not cover speech channels. Time slots 1-31 can be allocated for the following purposes:

ISDN and PSTN (PSTN, Public Switched Telephone Network) B-channel,

communication channel carrying ISDN D-channel information, PSTN-signalling or control data, or

communication channel carrying data pertaining to the Control protocol, Link Control protocol, Protection protocol or BCC protocol of the V5 interface.

The V5.2 interface specification includes the Control and PSTN protocols. Some of the functions of the Control protocol are e.g. to provide signalling channels in conjunction with call setup, control the states of subscriber ports and cooperate with the Protection protocol in a situation where a signalling channel connection is broken off. One of the functions of the PSTN protocol is e.g. to transmit subscriber line status data to the access node in the case of an analog subscriber. The PSTN protocol additionally functions as a means of communicating with national PSTN specifications. The protocols associated with the V5 interface are described in greater detail in ETSI standard series ETS 300 324 and ETS 300 347.

When a call is to be set up from a local exchange to an access node or vice versa, the local exchange selects the link to be used in the V5.2 interface and a suitable time slot in that link. The BCC protocol defined by the V5 standard gives the access node the link and time slot data so that the call can be set up. In a congestion situation, there may be no resource available for the call in the interface between the access node and the local exchange because of an overload in the interface, in which case the call cannot be set up. In practice, the calling subscriber does not necessarily even get a dial tone because the subscriber cannot be connected to the access node. This means that all speech time slots in the V5 interface are busy.

The ETSI standard series ETS 300 347 includes definition to the effect that, in the event of overload in the local exchange or in both the local exchange and the access node, the local exchange may command the access node to buffer the messages. In practice, this means that call setup would be suspended for a desired period of time. This involves the difficulty that the information regarding buffering of messages cannot be passed backwards to the call control system or to telephone exchanges behind the junction line. Buffering the messages will lead in certain situations in the telephone exchange to an uncontrolled setdown of calls and to other completely unforeseeable occurrences.

The standard series dealing with the V5 interface specifies that an overloaded party may stop second-layer message traffic altogether. However, this would result in breaking off ongoing calls.

Further, according to the standard, the local exchange may omit responding to the initial message for a new call sent by the access node. In this case, the access node will repeat sending the initial message for the new call at a few seconds, intervals until the subscriber hangs up or the overload is cleared. If responding to a call setup request or disconnect request is omitted when an overload is prevailing in the signalling channel, then the access node will continue sending the establish/disconnect message.

In an overload situation where no resources are available, it is not necessarily possible to inform the subscriber about the overload situation by a signal tone or a message. Even if a signal tone could be given, the subscriber normally makes new call setup attempts by on-hooking and off-hooking the receiver several times. All these call attempts are transmitted to the telephone exchange and they further aggravate a possible overload situation in the signalling channel and also in the message bus of the telephone exchange because all call attempts have to be handled properly as far as possible. A further disadvantage is that they impair the availability of resources to those who really need them—e.g. priority subscribers or emergency calls.

At present, the local exchange can limit the number of calls terminating at the access node without impairing the service, but in the access node there is no corresponding mechanism.

### OBJECT OF THE INVENTION

The object of the present invention is to eliminate the drawbacks referred to above or at least to significantly alleviate them. A specific object of the invention is to disclose a new type of method and system which enable the number of calls for outgoing connections to be limited already at the access node.

As for the features characteristic of the present invention, reference is made to the claims.

### BRIEF DESCRIPTION OF THE INVENTION

The invention concerns a method for clearing an overload situation in a telecommunication system comprising a first network element, a second network element, subscriber ports comprised in the network elements and an interface connecting the subscriber ports of the first network element to the subscriber ports of the second network element. The first network element is preferably a telephone exchange and of the DX200 model manufactured by the applicant. The second network element is preferably an access node and of the DAXnode 5000 model manufactured by the applicant. The interface is preferably a concentrating V5.2 interface.

In the method, the local exchange detects that the signalling channel between the network elements and/or the first network element are/is overloaded and no resources for call setup are available. Resources means e.g. time slots allocable for speech and signalling traffic. The local exchange detects congestion in the signalling channel when trying to get a free time slot for a new call. Because of congestion, no free time slot is found. When data regarding the subscriber's call attempt is sent by the second network element to the first network element, the first network element omits responding or inhibits the subscriber's call attempt because of congestion in the first network element. According to the invention, data indicating that the subscriber's call attempt is to be inhibited in the second network element is sent by the first network element to the second network element. If the subscriber still tries to set up a new call, the subscriber's call attempt is inhibited in the second network element. The first network element can define the length of the period during which the second network element is to inhibit the subscriber's call attempts. By virtue of this arrangement, the subscriber's repeated and in themselves fruitless new call attempts will terminate at the access node and will not cause unnecessary further congestion of other resources even so overloaded.

If an overload situation in the signalling channel and/or in the first network element is cleared, then it is possible to cancel the inhibition of the subscriber's call attempts in the second network element. The inhibition of the subscriber's call attempts pertaining to the second network element can be cancelled even if the period defined by the first network element has not yet elapsed. In this way, the period of inhibition of subscriber traffic due to overload is kept as short as possible.

It is possible to execute a priority class analysis on the subscriber in the first network element; based on the result, a decision is made as to whether the subscriber's call attempts are to be inhibited in the second network element or not. The first network element may comprise a database containing subscription-specific priority data. The subscriber's call attempts are inhibited in the second network element if the result of the priority class analysis allows this, i.e. if the subscriber does not belong to a prioritized subscriber class.

The above description refers to operation in the case of call setup initiated by the subscriber. In the case of a terminating call, the inhibition of the subscriber's call attempts in the second network element can be cancelled and the call to the subscriber can be set up normally.

The system of the invention comprises means for causing call attempt inhibition data to be sent by the first network element to the second network element and means for inhibiting a subscriber's call attempt in the second network element.

In an embodiment of the invention, the system comprises means for cancelling the inhibition of a subscriber's call attempts in the second network element.

In an embodiment of the invention, the system comprises means for performing a priority class analysis regarding a subscriber.

In an embodiment of the invention, the telecommunication system is a telephone exchange system.

In another embodiment, the first network element is a telephone exchange.

Using an implementation according to the invention, an overload situation in a signalling channel or local exchange is prevented in a controlled manner from getting worse. At the same time, the availability of lines and speech channels is considerably improved.

### LIST OF ILLUSTRATIONS

In the following, the invention will be described in detail by the aid of a few examples of its embodiments, wherein

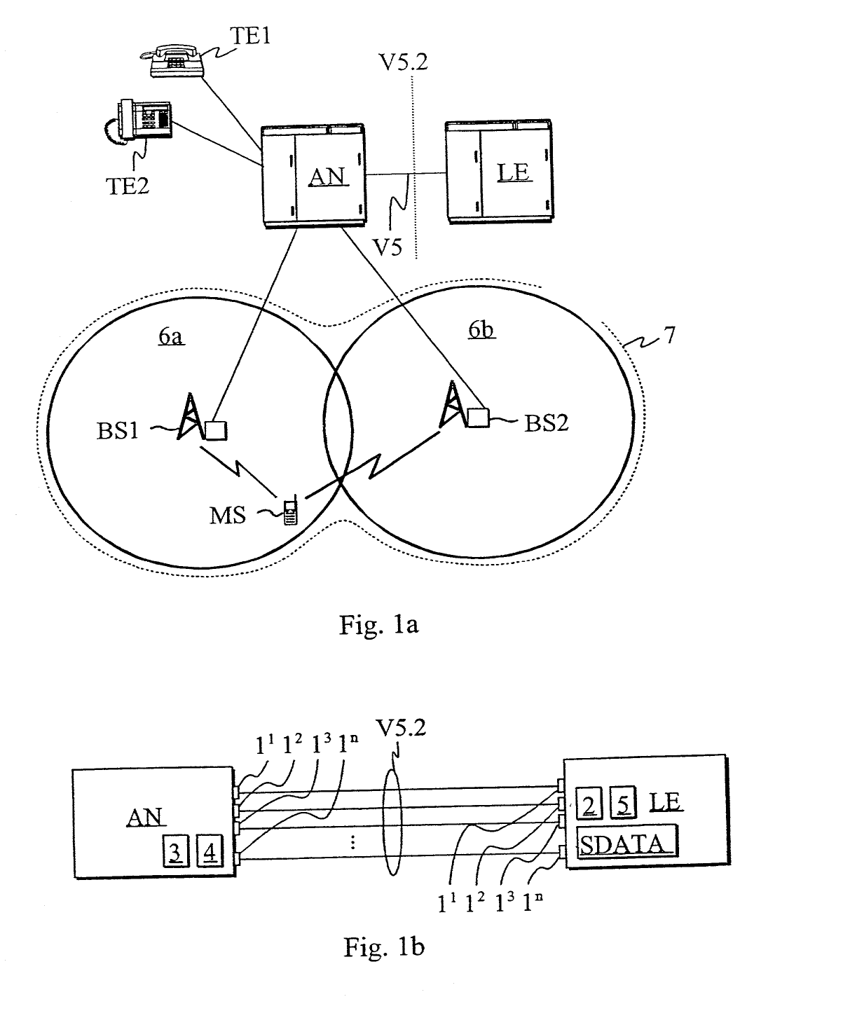

FIG. 1a presents diagram representing a telecommunication system in which the invention can be applied,

FIG. 1b presents diagram representing a system according to the invention,

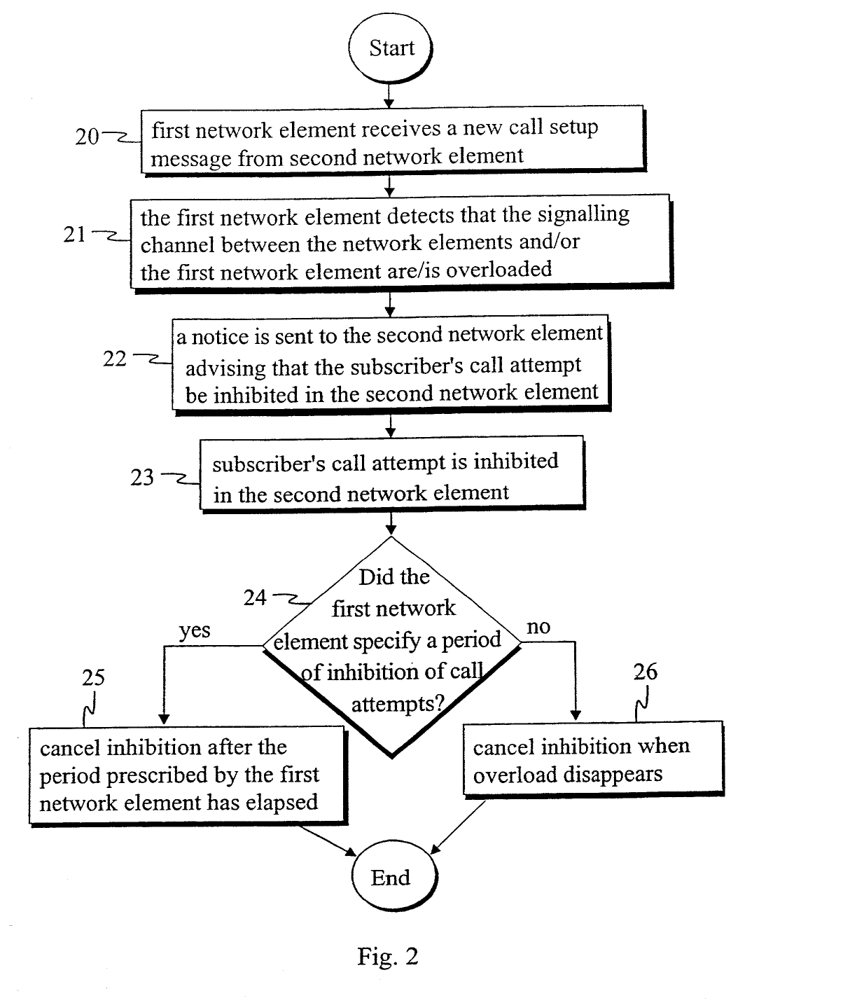

FIG. 2 presents a flow diagram as an example of the operation of the present invention, and

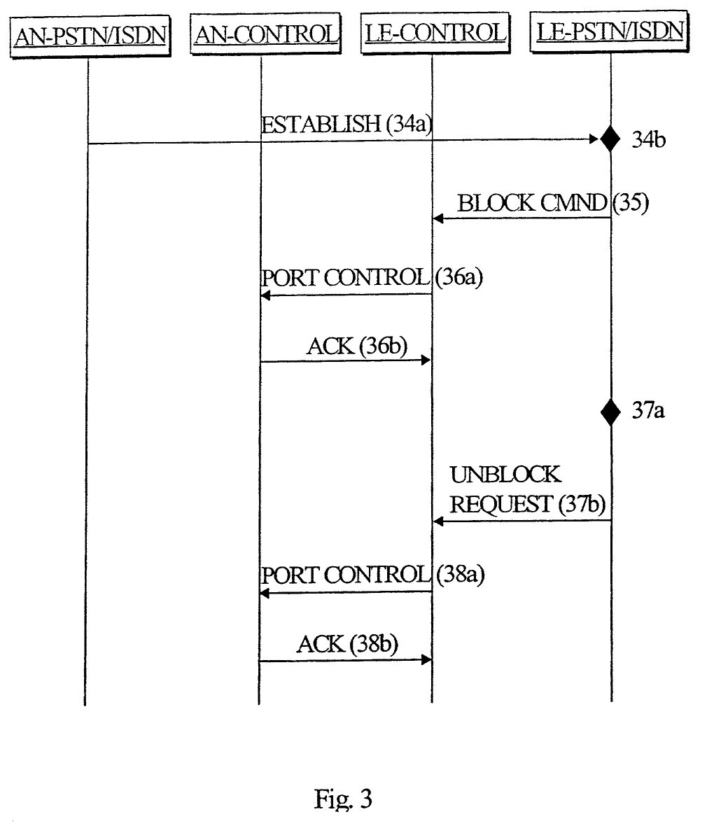

FIG. 3 presents a signal flow diagram representing a preferred example of the operation of the invention.

### DETAILED DESCRIPTION OF THE INVENTION

FIG. 1a presents an example of a system in which the present invention can be applied. The system comprises a local exchange LE and an access node AN connected to the local exchange via a V5 interface. The interface between the local exchange and the access node is called a V5.2 interface. The functionality of the V5.2 interface and the interface itself are described in detail in the above-mentioned standard series ETS 300 347.

Subscribers can be connected to the local exchange LE and to the access node AN in many different ways. FIG. 1a illustrates a few ways of connection by way of example. Connected directly to the access node are two telecommunication terminals. In this example, terminal TE1 represents an analog telephone and terminal TE2 a digital ISDN telephone. Also connected to the access node is a wireless local loop system WLL (WLL, Wireless Local Loop), in which a terminal MS is connected to the access node via the wireless local loop. The wireless local loop comprises at least one base station BS, which is connected via an Abis interface to the access node AN. This example comprises two base stations BS1 and BS2, which constitute cell areas 6a and 6b. The access node controls the operation of the base stations. Together, the cell areas form a mobility area 7, which is the operating range defined in this example for the terminal MS. The access node is connected via a V5 interface to the local exchange, so the terminal MS in the WLL system is seen by the local exchange as a normal wired-network subscriber.

FIG. 1b presents a system comprising a V5.2 interface as defined by the standard series ETS 300 347. The system illustrated in FIG. 1b comprises an access node AN and a local exchange LE. In this example, the access node is connected to the local exchange via V5.2 interface.

Each network element LE, AN comprises subscriber ports. In FIG. 1b, these are indicated by reference numbers 1¹, 1², 1³, . . . , 1¹¹. The subscriber ports of the two network elements are interconnected via a V5 interface. The local exchange LE comprises a program block 2 which serves to send call attempt inhibition data to the other network element. Program block 2 means e.g. a program block that implements the functions required by the Control protocol in the local exchange. The local exchange comprises a subscriber database SDATA storing subscriber-specific data. Stored in the subscriber database is e.g. subscription-specific priority data. The priority data means e.g. that each subscription belongs to a given subscriber group having a certain concentration. Attributes descriptive of concentration are e.g. normal, uninhibited, and so on. These define the subscriber's position as resources become scarce. In program block 5, a priority class analysis is performed on the subscriber on the basis of the data contained in the subscriber database SDATA.

The access node AN comprises a program block 3 used to inhibit the subscriber's call attempts upon a request by the local exchange LE. In practice, program block 3 serves to block call setup messages from the subscriber port 1. In conjunction with the transmission of the call attempt inhibition data, the local exchange may send to the access node data indicating the duration of validity of the inhibition. The access node additionally comprises a program block 4 which serves to cancel the inhibition of a subscriber's call attempts. Using program block 4, the subscriber port 1 is unblocked, thus allowing the subscriber again to set up outgoing calls. Program blocks 3 and 4 represent e.g. a program block which executes in the access node the functions required by the Control protocol.

Program blocks 2 - 4 may be a part of a larger subscriber signalling unit SSU. The function of the subscriber signalling unit is to take care of signalling pertaining to calls.

FIG. 2 presents a flow diagram representing a preferred example of the operation of the present invention.

According to FIG. 2, a first network element receives a new call setup message from a second network element. FIG. 3 gives a more detailed illustration of the message traffic and the parties involved in the message traffic.

According to block 21, the first network element detects that the signalling channel between the network elements and/or the first network element are/is overloaded and that there are no resources available for call setup. ‘Resources’, preferably refers to time slots allocable for speech and signalling traffic. The first network element detects congestion in the signalling channel when trying to find a free time slot for the new call. Because of the congestion, no free time slot is found. The first network element now inhibits the call setup requested in block 20 and sends to the second network element information to the effect that the subscriber's call attempts are to be inhibited already in the second network element, block 22. At the same time, the first network element can indicate to the second network element a period of time during which the inhibition should remain valid. According to block 23, new call attempts by the subscriber are inhibited in the second network element.

In block 24, the data sent by the first network element is checked to establish whether it gives the second network element a period of time during which the subscriber's call attempts are to be inhibited. When action proceeds to block 25, the inhibition of call attempts is cancelled in the second network element after the period of time prescribed by the first network element has elapsed. If no period of validity of the inhibition of call attempts was prescribed by the first network element, then the inhibition is cancelled when the overload situation disappears, block 26. The inhibition as in block 25 can also be cancelled earlier if the overload situation disappears before the period prescribed by the first network element has elapsed.

FIG. 3 presents a preferred example of the signalling used in operation according to the invention. The example in FIG. 3 comprises the PSTN/ISDN protocol AN-PSTN/ISDN of the access node, the Control protocol AN-CONTROL of the access node, the Control protocol LE-CONTROL of the local exchange and the PSTN/ISDN protocol LE-PSTN/ISDN of the local exchange.

The LE-PSTN/ISDN of the local exchange receives from the corresponding protocol of the access node a call setup request ESTABLISH, arrow 34a. Diamond 34b means that a priority class analysis is performed on the calling subscriber in the local exchange. The local exchange has a special subscriber database SDATA as presented in FIG. 2, storing subscription-specific priority data. The priority data indicates e.g. whether the local exchange has the right to inhibit a certain subscriber's call attempts e.g. because of an overload situation.

A situation may be encountered in which the signalling channel between the local exchange and the access node and/or the access node itself are/is overloaded. In this situation, LE-PSTN/ISDN sends to the LE-CONTROL protocol a BLOCK CMND message if the priority class analysis performed on the subscriber allows it, arrow 35. This occurs e.g. in the case of an ordinary subscriber. The LE-CONTROL protocol sends to the corresponding protocol of the access node a PORT CONTROL message, by means of which a given subscriber port is blocked, i.e. use of the subscriber port is inhibited, arrow 36a. The AN-CONTROL protocol of the access node acknowledges the block request by returning an ACK message, arrow 36b. After this, the subscriber will not be able to establish a call before the local exchange unblocks the subscriber port. In the case of a terminating call, the local exchange can unblock the subscriber port before the end of the blockage period and set up the call in the normal manner. The local exchange may indicate to the access node a period of time after which the subscriber port may be unblocked.

Diamond 37a signifies e.g. that an overload situation in the signalling channel or local exchange disappears. The LE-PSTN/ISDN protocol sends to the LECONTROL protocol an UNBLOCK REQUEST message asking the access node to unblock the subscriber port, arrow 37b. The LE-CONTROL protocol sends to the corresponding protocol of the access node a PORT CONTROL message requesting the access node to unblock the subscriber port, arrow 38a. The AN-CONTROL protocol of the access node acknowledges the blockage request by returning an ACK message, arrow 38b. After the subscriber port has been unblocked, the subscriber is again allowed to set up calls. After the local-exchange specific period of blockage of the subscriber port has elapsed, the local exchange may unblock the subscriber port or maintain the blockage as long as necessary in view of the overload situation.

The invention is not restricted to the examples of its embodiments described above; instead, many variations are possible within the scope of the inventive idea defined in the claims.

1. Method for clearing an overload situation in a telecommunication system comprising:
a first network element (LE);
a second network element (AN);
subscriber ports (1, 1¹, 1², 1³, . . . ) comprised in said network elements (LE, AN); and
an interface (V5) connecting the subscriber ports of the first network element (LE) to the subscriber ports of the second network element (AN),
in which telecommunication system:
a subscriber's call attempt is transmitted by the second network element (AN) to the first network element (LE);
it is detected that the signalling channel between the network elements (LE, AN) and/or the first network element (LE) are/is overloaded;
the subscriber's call attempt is inhibited in the first network element (LE);
characterized in that the method comprises the steps of:
causing a notice advising that the subscriber's call attempt is to be inhibited in the second network element (AN) to be sent by the first network element (LE) to the second network element (AN); and
inhibiting the subscriber's call attempt in the second network element (AN).

2. Method as defined in claim 1, characterized in that the subscriber's call attempt is inhibited in the second network element (AN) during a period of time prescribed by the first network element (Le).

3. Method as defined in claim 1 or 2, characterized in that the inhibition of the subscriber's call attempt in the second network element (AN) is cancelled if the overload situation in the signalling channel and/or first network element (LE) is cleared.

4. Method as defined in any one of the preceding claims 1-3, characterized in that the inhibition of the subscriber's call attempt in the second network element (AN) is cancelled even if the period of time prescribed by the first network element (LE) has not yet elapsed.

5. Method as defined in any one of the preceding claims 1-4, characterized in that
a priority class analysis regarding the subscriber is performed in the first network element (LE); and
the subscriber's call attempts are inhibited in the second network element (AN) if the result of the priority class analysis permits it.

6. Method as defined in any one of the preceding claims 1-5, characterized in that, in the case of a terminating call,
the inhibition of the subscriber's call attempt in the second network element (AN) is cancelled; and
the call is set up in the normal manner.

7. Method as defined in any one of the preceding claims 1-6, characterized in that the interface (V5) is a V5.2 interface.

8. System for clearing an overload situation in a telecommunication system comprising:
a first network element (LE);
a second network element (AN);
subscriber ports (1, 1¹, 1², 1³, . . . ) comprised in said network elements (LE, AN); and
an interface (V5) connecting the subscriber ports of the first network element (LE) to the subscriber ports of the second network element (AN),
in which telecommunication system:
a subscriber's call attempt is transmitted by the second network element (AN) to the first network element ment (LE);
it is detected that the signalling channel between the network elements (LE, AN) and/or the first network element (LE) are/is overloaded;
the subscriber's call attempt is inhibited in the first network element (LE);
characterized in that the system comprises:
means (2) for causing the first network element (LE) to send a call inhibition notice to the second network element (AN); and
means (3) for inhibiting the subscriber's call attempt in the second network element (AN).

9. System as defined in claim 8, characterized in that system comprises means (4) for cancelling the inhibition of the subscriber's call attempt in the second network element (AN).

10. System as defined in claim 8 or 9, characterized in that the system comprises means (5) for performing a priority class analysis regarding the subscriber.

11. System as defined in any one of the preceding claims 8-10, characterized in that the interface (V5) is a V5.2 interface.

12. System as defined in any one of the preceding claims 8-11, characterized in that the telecommunication system is a telephone exchange system.

13. System as defined in any one of the preceding claims 8-12, characterized in that the first network element (LE) is a telephone exchange.
